(19) United States
(12) Patent Application Publication
(10) Pub. No.: US 2020/0286134 A1
(43) Pub. Date: Sep. 10, 2020

(54) CHARITY ESCROW AND TRUST AUTO-ADMINISTRATION SYSTEM

(71) Applicant: Bank of America Corporation, Charlotte, NC (US)

(72) Inventor: Manu Kurian, Dallas, TX (US)

(21) Appl. No.: 16/294,556

(22) Filed: Mar. 6, 2019

(51) Int. Cl. G06Q 30/02; G06F 16/9535; G06Q 50/00

(52) U.S. Cl. CPC G06Q 30/0279; G06Q 50/01; G06F 16/9535

(57) ABSTRACT

A method for administering a charitable trust is provided. The method may include receiving a plurality of donor profiles, and scoring each donor profile using a multi-faceted metric. The method may include receiving a plurality of charity profiles, and scoring each charity profile using the multi-faceted metric. The multi-faceted metric may relate to gift categories, personal donor data and/or charity data. The method may include receiving funds from a first donor associated with a first donor profile. The method may include scoring the received funds based on the multi-faceted metric. The method may include allocating the funds to one or more charities. The one or more charities may be associated with one or more charity profiles included in the plurality of charity profiles. The similarity between the scoring of the one or more charity profiles and the first donor profile is within a predetermined similarity range.

### FIELD OF TECHNOLOGY

This disclosure relates to charity administration.

### BACKGROUND

Traditionally, non-profit organizations are funded by donations received from individuals, foundations, bequests and corporations. Many times, donors are inclined to donate to specific causes or types or causes. However, the donors may not have the knowledge of which organizations are an appropriate match with their favored causes.

It would be desirable, therefore, to implement a system that receives and retrieves data relating to donor predispositions, and appropriately matches donations received with organizations that match the donor predispositions.

### SUMMARY OF THE DISCLOSURE

An escrow administration system is provided. The escrow administration system may include an escrow.

The escrow may store, electronically or physically, a plurality of items of value. Each item of value may be associated with a donor profile. Each item of value may be tagged with an associated donor profile tag.

The system may include a distribution subsystem. The distribution subsystem may include a receiver. The receiver may be operable to receive notification of an event. The receiver may be operable to receive an organization profile. The organization profile may be associated with an organization. The organization profile may be directed towards relief for the event.

The organization profile may include a category associated with the organization. In one embodiment, the category may be a type of religion, education, human services, foundations, health, individuals, public society benefit, arts, culture, humanities, international affairs, environment and/or animals.

The organization profile may also include an urgency metric associated with the event. For example, the event may be a hurricane, and the organization may be directed towards short-term hurricane relief. The urgency metric may be relatively high, such as 80 out of 100, because the need may be emergent.

The system may also include a comparison module. The comparison module may compare the organization profile to the donor profiles included in the escrow.

The system may also include a determination module. The determination module may determine, based on the comparison, whether, within the escrow, there exists one or more items of value with a donor profile tag that corresponds to the organization profile.

The system may also include an allocation module. The allocation module may allocate the one or more items of value to the organization when there exists an item of value with a donor profile tag that corresponds to the organization profile.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the invention;

FIG. 2 shows another illustrative diagram in accordance with principles of the invention;

FIG. 3 shows yet another illustrative diagram in accordance with principles of the invention;

FIG. 4 shows still another illustrative diagram in accordance with principles of the invention;

FIG. 5 shows yet another illustrative diagram in accordance with principles of the invention;

FIG. 6 shows still another illustrative diagram in accordance with principles of the invention; and

FIG. 7 shows yet another illustrative diagram in accordance with principles of the invention.

### DETAILED DESCRIPTION

A system and method for retrieving social media data and allocating received items of value based on the social media data is provided. The method may include receiving an item of value. The method may include storing the item of value. Storing the item of value may enable the item of value to be set aside for charity, although the specific charity may be determined at a time other than the time of donation.

The method may include retrieving social media account history and/or other data regarding the donor. The social media account history and/or other data comprises one or more indications of the donor's fidelity to one or more charities. The indications may be posted and/or transmitted by the donor. The indications may be posted and/or transmitted by an entity other than the donor. Such an entity may be a friend of the donor.

The method may include creating a donor profile for the donor. The donor profile may include the one or more indications. The method may include linking the item of value to the donor profile. The method may include storing the item of value linked to the donor profile. In some embodiments, the donor profile may be copied and stored in a storage location adjacent to the item of value.

The method may include receiving an event report. The event report may include data relating to the event. The event report may include one or more organizations directed towards relief for the event.

The method may include determining whether a similarity between the one or more charities, included in the donor profile, and the one or more organizations, is above a predetermined similarity threshold.

The method may include, in one embodiment, requesting permission from the donor to allocate the item of value to one or more organizations when the similarity is determined to be above the predetermined threshold.

The method may include allocating the item of value to the one or more organizations upon receipt of permission form the donor.

In some embodiments, the method may include scoring each donor profile and each charity profile using a multi-faceted metric. The multi-faceted metric may relate to gift categories, personal donor data and/or charity data. The personal donor data and/or the charity data may be retrieved from one or more social media accounts. The personal donor data may also be retrieved from responses to a donor's personal questionnaire. The charity data may be retrieved from responses to a charity's questionnaire. The charity data may also be retrieved from the charity's Form 990. A Form 990 may be a return of organization exempt from income tax United States Interval Revenue Service form that provides the government and the public financial information about a non-profit organization. Most charities and/or organizations are required to make their Form 990 accessible to the public. A form 990 may include a percentage of funds given to the actual charity target. The charity data may also be retrieved from news and/or weather transmissions.

The system may include creating initial profiles in a charitable trust engine for each donor included in a plurality of donors. The donor profile may include specific charity organizations, types of charity organizations and a score level associated with each type of charity. The engine may include a scoring mechanism based on real-time data including social media, news, weather and/or important events. When disaster events occur, or important fundraising events take place, the events may be assigned a score. The event scores may be compared to pre-set scores in the donor's profile, thereby enabling donations to be adjusted and redirected based on the scoring.

In some embodiments, the system may include a charity research tool. The charity research tool may retrieve data relating to various charities. For example, the charity research tool may gather details about the charities. Therefore, the charity research tool may compare the gathered details of various similar charities. The charity research tool may present the comparison to a donor. For example, a hurricane occurs in Miami Beach, Fla. The charity research tool may retrieve details on five distinct charities that are directed to relief of the hurricane. The charity research tool may create a comparison between the data details retrieved for each of the five distinct charities. The charity research tool may present a comparison report that includes the comparison to a prospective donor.

In other embodiments, the system may include a tax and document module. The tax and document module may collect evidence relating to a charity for tax and document purposes. The tax and document module may include a full audit trail for each document retrieved. The tax and document module may enable greater transparency to be provided to, and documented for use by, donors. The tax and document module may also enable a charity to provide more accurate data, in shorten time spans, to government agencies. For example, the system may show a timeline and/or usage diagram of funds from the time the funds are received until the final usage of the funds.

In some embodiments, the system may combine funds from different donor in order to increase funds for a specific organization. One example of a combination may be donor matching. Donor matching may be when a specific donor states that, for a specific fundraising event, he will match—i.e., donate the same amount of funds—any donation given. Donor matching, and other sort of combinations funds may maximize gifts given to a specific target.

In some embodiments, the system may maximize funds, items of value and/or volunteer abilities by finding prospective, and creating, synergies between organizations. The system may recommend the interaction or cooperation of two or more organizations to produce a combined organization that is greater than the sum of their separate organizations.

Upon identification of a possible synergy relationship, the system may transmit a query to a first organization. The query may include whether the first organization would consider cooperating with an anonymous second organization. The query may also include whether the first organization consents to the system furnishing a portion of the first organization's data to the second organization. The system may then transmit a query to the second organization. The query may include the data that the first organization consented to be transmitted. In the event that both the first organization and second organization are in agreement to cooperate, the system may facilitate a cooperative organization.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

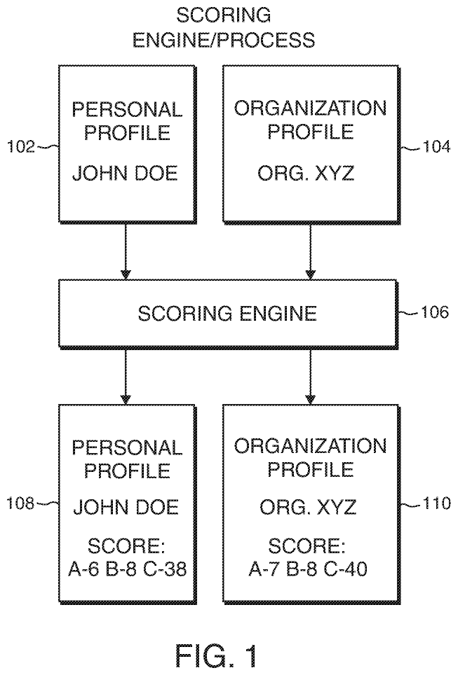

FIG. 1 shows a scoring engine and/or scoring process. Scoring engine 106 may receive and, in some embodiments, retrieve and/or generate, personal profile 102. Personal profile 102 may include data and/or metadata relating to a fictional individual named John Doe. The data and/or metadata relating to the individual John Doe may include personal data, such as name, address(es) and telephone number(s).

The data and/or metadata relating to the individual named John Doe may include data retrieved from a questionnaire populated and transmitted by John Doe. The questionnaire may relate to charity preferences. The charity preferences may include preferable charity categories. The individual may select charity categories to which he would like to donate. Examples of charity categories may include religion, education, human services, foundations, health, individuals, public society benefit, arts, culture, humanities, international affairs, environment and animals.

In order to determine what an individual considers significant with respect to his charitable donations; the questionnaire may include other metrics. A portion of the metrics may request a yes or no response. Another portion of the metrics may request variable responses. An example of a question included in the questionnaire may be: Is a charity's chief operating officer's salary significant to your donation decisioning? Another example of a question included in the questionnaire may be: What are examples of charity categories to which you would like to donate? Yet another example of a question included in the questionnaire may be: Select five gift categories that are most important to you—education, religion, humanities, arts, culture, sciences, health, public-society, environment, animals, international affairs.

Organization profile 104 may relate to fictional organization Org. XYZ. Organization profile 104 may include data relating to Org. XYZ. The data relating to Org. XYZ may be geographical data, location data, organization type, organization mission data, organization urgency data and any other suitable data.

Scoring engine 106 may score personal profile 102 and organization profile 104 based on the data included in each profile. Scoring engine may include a variety of metrics. Each metric may relate to various components of the profile. For example, one metric may be a geographic metric. The geographic metric may identify a location associated with personal profile 102. The geographic metric may also identify a location associated with organization profile 104.

Another metric may be a category metric. The category metric may identify one or more categories associated with personal profile 102. The category metric may also identify one or more categories associated with organization profile 104.

After scoring engine 106 scores personal profile 102, scoring engine 106 releases an updated personal profile 108. Updated personal profile 108 may include the data included in personal profile 102. Updated personal profile 108 may also include scores received from scoring engine 106.

After scoring engine 106 scores organization profile 104, scoring engine 106 releases an updated organization profile 110. Updated organization profile 110 may include the data included in organization profile 110. Updated organization profile 110 may also include the data received from scoring engine 110.

It should be appreciated that the scores received from scoring engine 110 may be multi-faceted scores. The scores may include multiple components, such as a category component, an urgency component, a location component and/or any other suitable component. It should be appreciated that one component may be weighted more heavily than another component. In an example, for a first personal profile, location may be more important than category. In another example, for a second personal profile, urgency may supersede category and location. Therefore, a donation associated with a second personal profile may be allocated to an urgent need that is 50% similar to the second profile's selected category rather than a non-urgent need that is 85% similar to the second profile's selected category.

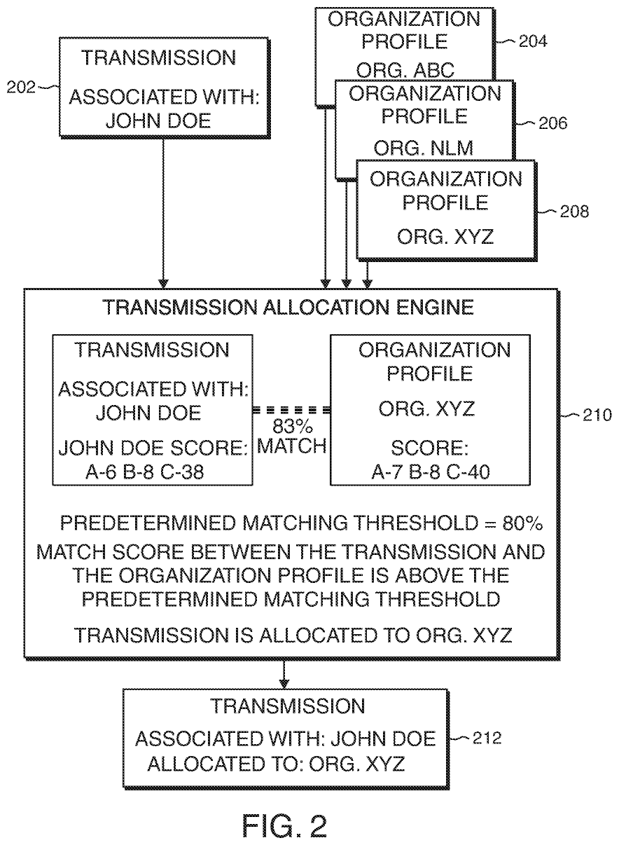

FIG. 2 shows transmission allocation engine 210. Transmission allocation engine may allocate received transmissions with appropriate organizations based on matching between transmission scores and organization profile scores.

Transmission allocation engine 210 may receive transmission 202. Transmission 202 may be associated with fictional person John Doe. Fictional person John Doe may have donated transmission 202. Fictional person John Doe may be associated with a personal profile, such as personal profile 102 (shown in FIG. 1).

Transmission allocation engine 210 may receive organization profiles 204, 206 and 208. Organization profile 204 may be associated with organization ABC. Organization profile 206 may be associated with organization NLM. Organization profile 208 may be associated with organization XYZ. Organization profiles 204, 206 and 208 may include data received from the organization itself and may also include data retrieved from an outside source regarding the organization.

Transmission allocation engine 210 may match transmissions with organizations. The matching may be based on the scores associated with the transmissions and the organizations. A score for a transmission may be retrieved from a donor profile or personal profile associated with the transmission donor. An organization profile may be received, as shown at 204, 206 and 208.

Transmission 202 may be associated with fictional person John Doe. Fictional person John Doe may be associated with a personal profile. The score associated with John Doe's personal profile may be A-6 B-8 C-38. Therefore, the score associated with transmission 202 may be A-6 B-8 C-38. Organization profile 208 may be scored A-7 B-8 C-40. The transmission allocation engine may perform a comparison between the score associated with transmission 202 and the score associated with organization profile 208. Transmission allocation engine 210 may identify a percentage of matching between transmission 202 and organization profile 208. The percentage of matching shown may be 83%. Transmission allocation engine may also include a predetermined matching threshold. The predetermined matching threshold may be a percentage level in which the transmission may be allocated to the organization profile. Transmission allocation engine 210 may include a predetermined matching threshold of 80%. Therefore, matching percentages that are determined to be above 80% may be allocated, while matching percentages that are determined to be below 80% may not be allocated.

Because the matching percentage shown, within transmission allocation engine 210, may be 83%, transmission 202 may be allocated to organization XYZ. Transmission 202 may be tagged with the donor association and the organization allocation, as shown at 212. Upon allocation, the donor may be notified of the allocation, and the usage of the transmission. In some embodiments, videos or pictures, or other media associated with the allocation and/or venues of allocation, may be made available to the donor, such as donor John Doe.

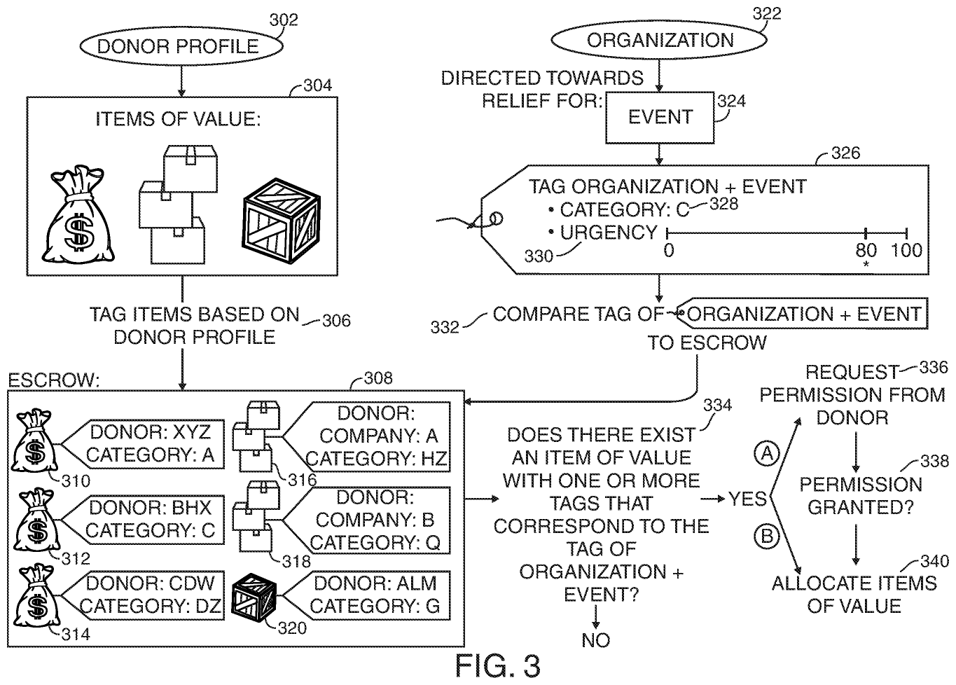

FIG. 3 shows an illustrative diagram. A donor may donate one or more items of value 304. Items of value 304 may include funds, bonds, crypto-currency, goods, physical items and any other suitable items.

The donor may be associated with donor profile 302. Each item of value may be tagged with the donor profile associated with the donor of the item of value. In some embodiments, the donor profile may be stored as metadata together with an electronic storage of the item of value. In some embodiments, the metadata may be stored in a database, or other storage location, together with location information of the items of value.

The items of value may be stored in escrow 308. Escrow 308 may be a physical storage location. Escrow 308 may be an electronic storage medium. Escrow 308 may store items of value and associated metadata. Escrow 308 may store item of value 310. Item of value 310 may be funds. Item of value 310 may have been donated by donor XYZ. Item of value 310 may be associated with category A. Category A may have been retrieved from the donor profile associated with donor XYZ.

Escrow 308 may store item of value 312. Item of value 312 may be a trust fund. Item of value 312 may have been donated by donor BHX. Item of value 312 may be associated with category C. Category C may have been retrieved from the donor profile associated with donor BHX.

Escrow 308 may store item of value 314. Item of value 314 may be a bond. Item of value 314 may have been donated by donor CDW. Item of value 314 may be associated with category DZ. Category DZ may have been retrieved from the donor profile associated with donor CDW.

Escrow 308 may store item of value 316. Item of value 316 may be a pallet of suitcases. Item of value 316 may have been donated by donor Company A. Item of value 316 may be associated with category HZ. Category HZ may have been retrieved from the donor profile associated with donor Company A.

Escrow 308 may store item of value 318. Item of value 318 may be a pallet of cutlery. Item of value 318 may have been donated by donor Company B. Item of value 318 may be associated with category Q. Category Q may have been retrieved from the donor profile associated with donor Company B.

Escrow 308 may store item of value 320. Item of value 320 may be a shipping crate of various household goods. Item of value 320 may have been donated by donor ALM. Item of value 320 may be associated with category G. Category G may have been retrieved from the donor profile associated with donor ALM.

It should be appreciated that, although one category is shown for each of the items of value, multiple categories and/or other data may also be included. In some embodiments, a donor may tag an item of value stating that, preferably the item of value should be donated to category A, however, in the event of a natural disaster, the item of value may be donated to categories C or DZ.

Organization 322 may be directed towards relief of event 324. Organization 322, together with event 324, may be tagged, as shown at 326. The tag may include a category, as shown at 328. The tag may also include an urgency metric, as shown at 330. The urgency metric shown may be eighty on a scale of one through one hundred.

The tag of organization 322, together with event 324, may be compared to escrow 308, as shown at 332. The comparison may check if there exists an item of value with one or more tags that correspond to the tag of the organization in conjunction with the event, as shown at 334. If there does not exist an item of value, the process may terminate. If there does exist an item of value, the process may proceed either on path A or on path B. Path A may request permission from the donor, as shown at 336. The permission request may include data relating to the event and/or the organization and the item of value to be donated. If permission is granted, as shown at 338, the items of value may be allocated, as shown at 340. Path B may proceed directly to allocation without donor consent. In some embodiments, a donor may select whether he or she would want a permission request prior to donation allocation.

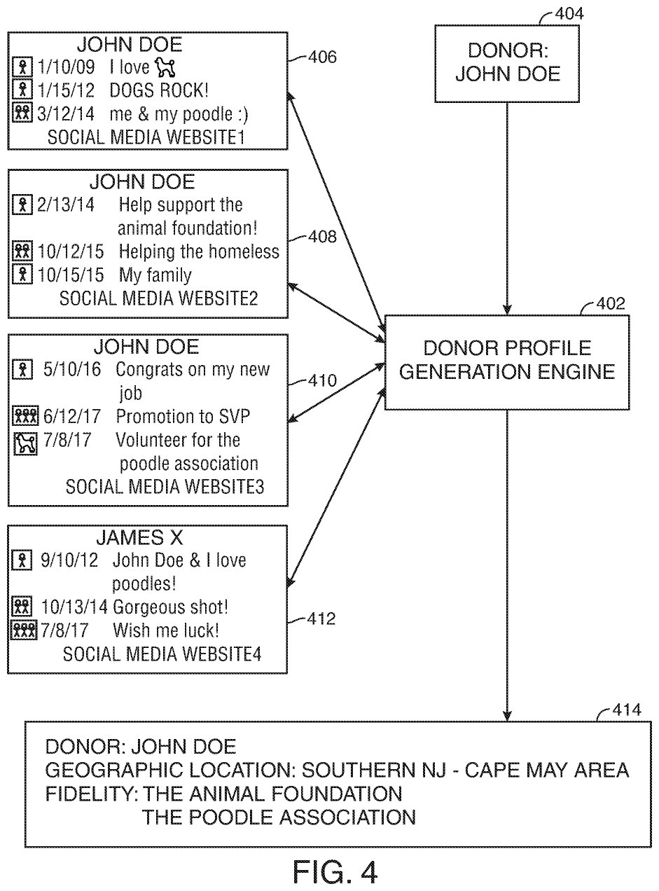

FIG. 4 shows donor profile generation engine 402. Donor 404 may register, as a donor, with donor profile generation engine 402. Donor 404 may donate funds and/or items of value. In some embodiments, donor 404 may not directly register with engine 402. However, as a result of a donation, donor 404 may be registered with donor profile engine 402.

Upon registration of donor 404 with donor profile generation engine 402, donor profile generation engine 402 may generate a donor profile for donor 404. Donor profile generation engine 402 may retrieve data relating to donor 404. The data may be retrieved from social media websites, such as social media website 1, shown at 406, social media website 2, shown at 408, social media website 3, shown at 410, and social media website 4, shown at 412.

Social media website 1, shown at 406, may show social media posts posted by John Doe. John Doe may have posted that “I love” and a photo of dogs on Jan. 10, 2009. John Doe may also have posted “Dogs Rock” on Jan. 15, 2012. John Doe may also have posted “me and my poodle:)” on Mar. 12, 2014. The posts shown on social media website 1 may indicate John Doe's fidelity and/or affinity towards animals and, specifically, dogs.

Social media website 2, shown at 408, may show social media posts posted by John Doe. John Doe may have posted “Help support the animal foundation” on Feb. 13, 2014. John Doe may have posted “helping the homeless” on Oct. 12, 2015. John Doe may have posted “my family” on Oct. 15, 2015. The posts shown on social media website 2 may indicate John Doe's fidelity and/or affinity towards the animal foundation and the homeless.

Social media website 3, shown at 410, may show social media posts posted by John Doe. John Doe may have posted “Congrats on my new job” on May 10, 2016. John Doe may also have posted his promotion to senior vice president on Jun. 12, 2017. John Doe may also have posted “volunteering for the poodle association” on Jul. 8, 2017. The posts shown on social media website 3 may indicate John Doe's workplace. The posts shown on social media website 3 may also indicate John Doe's geographic location. John Doe's geographic location may be assumed to be within a predetermined proximity to his workplace, which may be indicated by social media website 3.

Social media website 4, shown at 412, may show social media posts posted by James X. James X may indicate his association with John Doe and their joint affinity towards poodles, as shown in a Sep. 10, 2012 post. It should be appreciated that donor profile generation engine 402 may retrieve data from social media posts posted by donor 404 and social media posts posted about donor 404.

It should be appreciated that, there may be different methods of accessing social media accounts. For example, donor profile generation engine 402 may access John Doe's social media accounts using authentication information provided by John Doe. In another example, donor profile engine 402 may retrieve data about John Doe from third party social media accounts using a web crawler.

Donor profile generation engine 402 may, utilizing an artificial intelligence module, determine that John Doe has an affinity and/or fidelity towards dogs. Donor profile generation engine 402 may further determine, based on the data retrieved from the social media profile websites, that John Doe has an affinity towards two particular animal organizations—The Animal Foundation and The Poodle Association. Donor Profile generation engine 402 may further determine that donor John Doe is primarily located in the Southern New Jersey—Cape May area. Donor profile generation engine 402 may generate donor profile 414 based on the retrieved data.

In some embodiments, donor profile engine 402 may also utilize data provided by donor 404 in addition to the data retrieved from the social media websites.

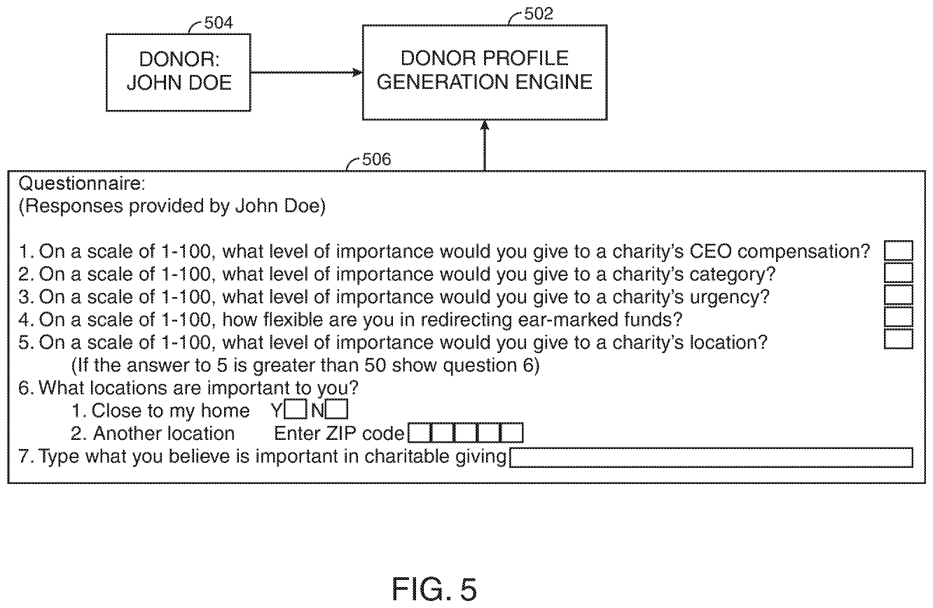

FIG. 5 shows donor profile generation engine 502. Donor profile generation engine 502 may generate a donor profile relating to donor 504. Donor 504 may respond to a questionnaire, such as questionnaire 506.

Questionnaire 506 may request data from donor 504. Questionnaire 506 may include yes and no questions and free form questions.

Questionnaire 506 may include the following questions: 1. On a scale of 1-100, what level of importance would you give to a charity's CEO compensation? (Enter a number from 1-100) 2. On a scale of 1-100, what level of importance would you give to a charity's category? (Enter a number from 1-100) 3. On a scale of 1-100, what level of importance would you give to a charity's urgency? (Enter a number from 1-100) 4. On a scale of 1-100, how flexible are you in redirecting ear-marked funds? (Enter a number from 1-100) 5. On a scale of 1-100, what level of importance would you give to a charity's location? (Enter a number from 1-100) 6. (Question 6 may be displayed if the answer to question 5 is greater than 50) What locations are important to you? Close to home? (select yes or no) Another location? (enter zip code) 7. Type what you believe is important in charitable giving: (Free form).

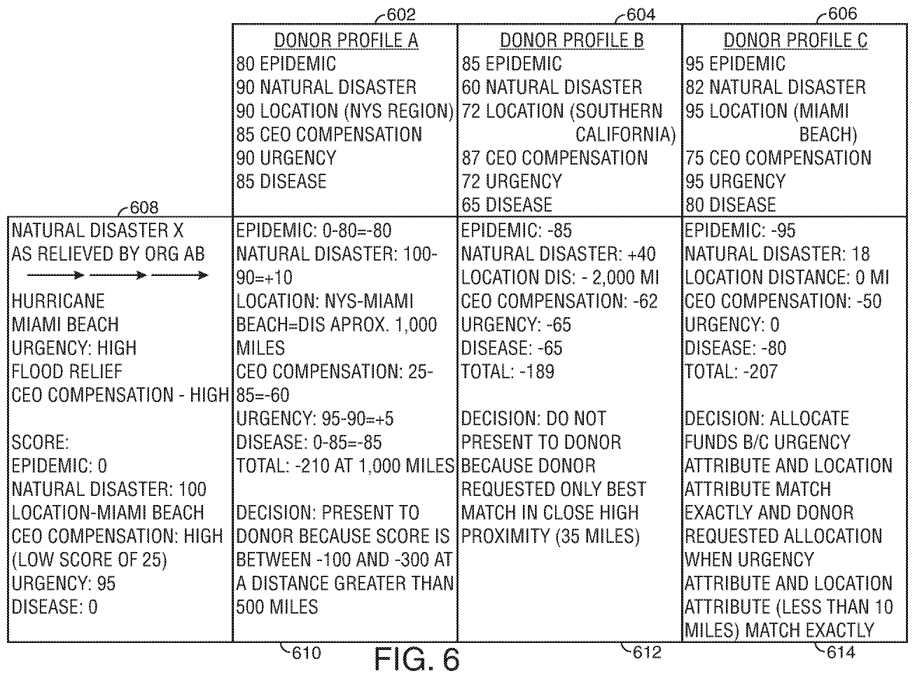

FIG. 6 shows an exemplary system-defined allocation system. The system may include donor profiles A, B and C, shown at 602, 604 and 606, respectively. Each donor profile may include a score for a variety of attributes. In some embodiments, a score for an attribute may be marked non-applicable.

Each donor profile may be retrieved from various sources, such as donor provided information and retrieved information. Each donor profile may be updated as different events occur. The updating may occur in real-time. The events may be world events, natural disasters, events occurring in a donor's life or any other suitable events. Each donor profile may be updated in real-time based on information that the donor provides.

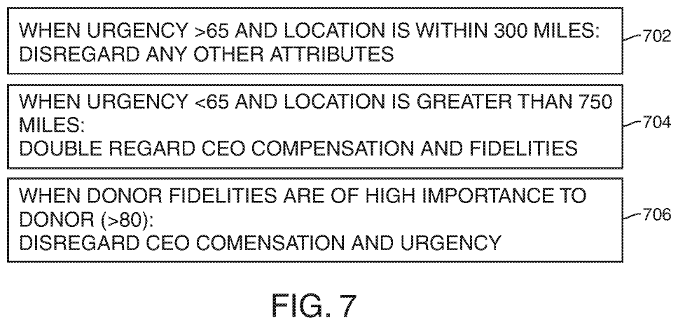

A profile of an event in combination with an organization directed toward the relief of the event may be shown at 608. The event may be a natural disaster, important fundraising event or any other suitable event. The scores associated with each event in combination with an organization may be compared to each donor profile. The comparison may be used, in combination with an algorithm, such as the algorithms shown on FIG. 7, in order to allocate funds and/or items of value.

It should be appreciated that, in some embodiments, an event may be associated with multiple organizations. In such embodiments, each distinct combination of an event and an organization may be scored and compared individually. There may be one or more collision algorithms to determine which organization for which donor takes precedence.

Donor profile A as compared to natural disaster as relieved by organization AB may be shown at 612. Each attribute included in donor profile A may be compared to each attribute included in natural disaster profile 608.

The comparison of donor profile A and natural disaster profile as relieved by organization AB 608 may include the following metrics: Donor profile A may include an epidemic attribute score of 80 (the donor may include a score of 80 out of 100 towards charities related to epidemics); Natural Disaster 608 may include an epidemic attribute score of 0 (natural disaster may not be related to an epidemic); the comparison score between donor profile A and natural disaster profile as relieved by organization AB 608 for the epidemic attribute may be −80. The comparison score between the natural disaster attributes may be 10—i.e., natural disaster profile 608 may have a natural disaster attribute score of 100 as compared to donor profile A natural disaster score of 90. The comparison score between the location attributes may be shown in mileage. The mileage distance may be one thousand miles. The comparison score between the CEO compensation attributes may be −60. The comparison score between the urgency attributes may be 5. The comparison score between the disease attributes may be −85. The total score shown, which may, in this exemplary scenario, be an addition of all the attribute scores, may be −210. The decision, based in part on the score, determined by an allocation engine, may be to present the natural disaster as relieved by organization AB profile to the donor associated with donor profile A because the score may be in between −100 and −300 and the event may occur at a distance greater than 500 miles.

The comparison between donor profile B and natural disaster as relieved by organization AB may be shown at 612. The decision, which may be based in part on the score and may be based in part on a donor's specific request, may be determined by an allocation engine. The decision may be to not present natural disaster as relieved by organization AB to the donor associated with donor profile B because, in addition to the score, the donor requested that only best match charities in close proximity (35 miles) be presented to the donor.

The comparison between donor profile C and natural disaster as relieved by organization AB may be shown at 614. The decision determined by an allocation engine may be to allocate funds received by a donor associated with donor profile C to natural disaster as relieved by organization AB because the urgency attribute may be an exact match and the location attribute may be an exact match, and the donor requested immediate allocation when an urgency attribute and a location attribute match exactly.

FIG. 7 shows exemplary system-defined algorithms for use with an allocation engine. The algorithm to be used may be donor-selected. The algorithm to be used may be selected by an artificial intelligence module. The algorithm to be used may be selected by any other suitable module, system or user. Algorithm 702 shows that when an urgency attribute is greater than 65 and the location is within 300 miles, all other attributes should be disregarded. Algorithm 704 shows that when an urgency attribute is less than 65 and the location is greater than 750 miles, CEO compensation attribute and donor fidelities should be regarded as twice as important. Algorithm 706 shows that when donor fidelities are of high importance to the donor (received a score greater than 80), the CEO compensation attribute and urgency attributes should be disregarded. In some embodiments, multiple algorithms may be combined.

Thus, apparatus and methods for a charity escrow and trust auto-administration system are provided. Persons skilled in the art will appreciate that the present invention can be practiced by other than the described embodiments, which are presented for purposes of illustration rather than of limitation. The present invention is limited only by the claims that follow.

What is claimed is:

1. A method for retrieving social media data and allocating received items of value based on the social media data, the system comprising:
receiving an item of value from a donor;
retrieving social media account history and/or other data regarding the donor, wherein the social media account history and/or other data comprises one or more indications of the donor's fidelity to one or more charities;
creating a donor profile for the donor, said donor profile comprising the one or more indications;
linking the item of value to the donor profile;
storing the item of value, linked to the donor profile;
receiving an event report, said event report comprising:
data relating to the event; and
one or more organizations directed towards relief for the event;
determining whether a similarity between the one or more of charities, included in the donor profile, and the one or more organizations, is above a predetermined similarity threshold;
when the similarity is determined to be above the predetermined threshold, requesting permission from the donor to allocate the item of value to the one or more organizations; and
upon receipt of permission from the donor, allocating the item of value to the one or more organizations.

2. The method of claim 1, wherein the one or more indications are posted/transmitted by the donor.

3. The method of claim 1, wherein the one or more indications are posted/transmitted by an entity other than the donor.

4. The method of claim 1, wherein the event is a disaster event.

5. The method of claim 1, wherein the event is an event initiated by the one or more organizations.

6. A method for administering a charitable trust, the method comprising:
receiving a plurality of donor profiles;
scoring each donor profile using a multi-faceted metric;
receiving a plurality of charity profiles;
scoring each charity profile using the multi-faceted metric;
receiving funds from a first donor, said first donor being associated with a first donor profile;
scoring the received funds based on the multi-faceted metric; and
allocating the funds to one or more charities, said one or more charities being associated with one or more charity profiles included in the plurality of charity profiles, wherein the similarity between the scoring of the one or more charity profiles and the scoring of the first donor profile is within a predetermined similarity range.

7. The method of claim 6, wherein the multi-faceted metric relates to gift categories, personal donor data and/or charity data.

8. The method of claim 7, wherein the gift categories include:
type of religion;
education;
human services;
foundations;
health;
individuals;
public society benefit;
arts, culture and humanities;
international affairs; and
environment/animals.

9. The method of claim 7, wherein the charity data is retrieved from the charity's Form 990.

10. The method of claim 7, wherein the charity data is retrieved from social media, news and/or weather data.

11. The method of claim 7, wherein the personal donor data is retrieved from social media.

12. The method of claim 7, wherein the personal donor data is retrieved from answers to a donor's personal questionnaire.

13. An escrow administration system, the system comprising:
an escrow, the escrow comprising:
a plurality of items of value, each item of value being associated with a donor profile, each item of value being tagged with an associated donor profile tag;
a distribution subsystem, the distribution subsystem comprising:
a receiver operable to receive:
a notification of an event; and
an organization profile, said organization profile associated with an organization, said organization profile directed towards relief for the event;
a comparison module configured to compare the organization profile to the donor profiles included in the escrow;
a determination module configured to determine, based on the comparison, whether, within the escrow, there exists items of value with a donor profile tag that corresponds to the organization profile; and
an allocation module configured to allocate the one or more items of value to the organization when there exists an item of value with a donor profile tag that corresponds to the organization profile.

14. The system of claim 13, wherein the organization profile comprises a category associated with the organization and an urgency metric associated with the event.

15. The system of claim 13, wherein the donor profile comprises one or more gift categories.

16. The system of claim 15, wherein the gift categories include:
type of religion;
education;
human services;
foundations;
health;
individuals;
public society benefit;
arts, culture and humanities;
international affairs; and/or environment/animals.

17. The system of claim 13, wherein the escrow is an electronic storage medium.
